(19) United States
(12) Patent Application Publication
(10) Pub. No.: US 2013/0318575 A1
(43) Pub. Date: Nov. 28, 2013

(54) METHOD AND APPARATUS FOR DYNAMIC AUTHENTICATION

(71) Applicants: Jason Dean Hart, Fremont, CA (US); Matthew Patrick Herscovitch, Fremont, CA (US)

(72) Inventors: Jason Dean Hart, Fremont, CA (US); Matthew Patrick Herscovitch, Fremont, CA (US)

(21) Appl. No.: 13/983,047

(22) PCT Filed: Feb. 3, 2012
(86) PCT No.: PCT/AU2012/000086

§ 371 Date: Aug. 15, 2013

(30) Foreign Application Priority Data
Feb. 3, 2011 (AU) 2011200445

(51) Int. Cl. H04L 29/06

(52) U.S. Cl. CPC H04L 63/0838
USPC 726/4; 726/9; 726/6

(57) ABSTRACT

One embodiment provides a token for dynamically authenticating a user. The token includes a memory for storing secure data; a processor for calculating authentication credentials of the user based on the secure data, and for constructing a server address based on the authentication credentials. Also included is a transmitter for transmitting the server address to a host controller wherein the host controller is configurable to communicate with a remote server locatable at the server address such that the user is dynamically authenticated on the remote server using the authentication credentials.

### FIELD OF THE INVENTION

The present invention relates to user authentication. More particularly, the invention provides a system and method for dynamically authenticating a user using a security token, and is described predominantly in this context. However, it will be appreciated that the invention is not limited to this particular application.

### DESCRIPTION OF THE RELATED ART

The following discussion of the background art is intended to place the invention in an appropriate context and to enable various associated advantages to be more fully understood. However, any reference to background art throughout the specification should not be construed as an express or implied admission that such background art is widely known or forms part of common general knowledge in the field.

Presently, when access to a secure electronic service such as a website is required, the user accesses an initial entry page and enters his or her login information into the page. The portal then determines the user's credentials, for example by looking up a policy database, and matching the user's details with the information stored on the database. If there is a match, the user is granted access to the website in accordance with the access policy.

More secure services, such as some online banking websites, may require additional, custom-made software to be installed onto a user device. Examples of such software are digital IDs, certificates, software keys or cookies which are installed onto the user device.

There are several disadvantages to present authentication systems. First, a user needs to remember their login information. In present society, most users are already inundated by passwords and the like and so it is desirable to minimise the amount of information which must be remembered. This is especially true of login information for services that are not used frequently.

Additionally, it is not always possible or viable to install custom software onto the user device. For example, users wishing to access a service via their work computer are likely to face restrictions on installing software. The installation of the software also requires physical access to the client device. Typically, a website will provide instructions for a user, who naturally has physical access to the hardware, to install the software. However, this assumes a level of technical aptitude in the user which may not be realistic. Also, the software will have some minimum requirement to run. Therefore, this method assumes that the user's device is of a particular standard which it may not be. Finally, installing software is disadvantageous because, if a user accesses services through a number of devices, then the custom software must be installed on all the devices.

Further, present authentication systems may pose a security risk. Although the authentication system itself may be relatively secure, due to the way it is accessed, there are multiple opportunities for a security breach to occur. For example, a key logger may be used to steal login information as it is typed into a website, or the user may become the target of a “phishing” scam and inadvertently enter login information into a counterfeit website.

A system that may be used to partially address the above disadvantages is discussed in U.S. Pat. No. 6,690,402 assigned to NCR Corporation. In this document, a radio frequency (RF) tag is attached to an item, such as a piece of furniture. A uniform resource locator (URL) is encoded into the RF tag such that when the tag is scanned by a RF scanner, the user is taken to the URL web address. The RF scanner is in communication with an internet browser which is used to access the URL embedded in the tag. The assignees of U.S. Pat. No. 6,690,402 envisage providing additional information about the item using the RFID system. Therefore, returning to the above example, the URL encoded into the RF tag which is attached to a piece of furniture takes the user to an information page on the interne with specific details about that particular item of furniture.

However, this method requires additional hardware and software to be installed onto the client device. For example, if the client device is a personal computer, an additional RF scanner would need to be installed, along with specific software to interpret the scanned data.

This prior art system also does not consider security and authentication. As such, it could only be used for authentication purposes if the URL is kept secret, otherwise, anyone with knowledge of the URL would be able to access the electronic service.

The present invention advantageously provides a useful alternative to existing remote authentication systems.

### SUMMARY OF THE INVENTION

According to one aspect of the invention, there is provided a token for dynamically authenticating a user, said token including:

a memory for storing secure data;

a processor for calculating authentication credentials of said user based on said secure data, and for constructing a server address based on said authentication credentials; and

a transmitter for transmitting said server address to a host controller wherein said host controller is configurable to communicate with a remote server locatable at said server address such that said user is dynamically authenticated on said remote server using said authentication credentials.

Preferably the host controller is a mobile communications device configurable for communication with the remote server.

The secure data preferably includes a client key that corresponds to a host key stored on the host controller.

Preferably, the authentication credentials includes an encrypted one-time password that is generated based on the secure data. The secure data preferably includes a username for identifying a user and for determining whether the user has permission to access the remote server.

Preferably, the remote server is a webserver and said authentication credentials grants access to a website stored on said webserver.

The authentication credentials preferably only grants access to one section of said remote server. Preferably, access to other sections of the remote server is granted upon further authentication by the remote server.

The host controller preferably includes a proximity coupling device and the token is energised when brought into proximity with the proximity coupling device. Alternatively, the token is energised by a local energy source.

According to an aspect of the invention, there is provided a system for dynamically authenticating a user, said system including a token and a host controller, said host controller including:

a receiver for receiving said server address;

a network interface for locating and communicating with said remote server, wherein said authentication credentials are provided to said remote server thereby to authenticate said user.

According to an aspect of the invention, there is provided method for dynamically authenticating a user, said method including the steps of:

a) calculating authentication credentials of said user based on secure data stored on a token,

b) constructing a server address based on said authentication credentials; and

c) transmitting said server address to a host controller wherein said host controller is configurable to communicate with a remote server locatable at said server address, such that said user is dynamically authenticated on said remote server using said authentication credentials.

According to an aspect of the invention, there is provided a system for dynamically authenticating a user, said system including a token and a host controller, said token including:

a memory for storing secure data;

a processor for calculating authentication credentials of said user based on said secure data, and for constructing a server address based on said authentication credentials; and

a transmitter for transmitting said server address to a host controller wherein said host controller is configurable to communicate with a remote server locatable at said server address; and said host controller including:

a proximity coupling device for coupling with said token;

a receiver for receiving said server address;

a network interface for communicating with said remote server, wherein said authentication credentials are provided to said remote server thereby to dynamically authenticate said user.

### BRIEF DESCRIPTION OF THE DRAWINGS

The invention will now be described in a non-limiting manner with respect to a preferred embodiment in which:

FIG. 1 is an overview of the system for dynamically authenticating a user according to one aspect of the invention.

FIG. 2 is a schematic view of a smartcard according to one aspect of the invention.

FIG. 3 is a schematic view of a host controller according to one aspect of the invention.

FIG. 4 is a schematic view of the major components of the system for dynamically authenticating a user according to one aspect of the invention.

FIG. 5 is a flow diagram of the method for dynamically authenticating a user according to one aspect of the invention.

FIG. 6 is a flow diagram of the method for dynamically authenticating a user according to another aspect of the invention.

### DETAILED DESCRIPTION OF PREFERRED EMBODIMENTS

Described herein are methods and systems for dynamically authenticating a user. In overview, an electronic service provider issues a user with a token, such as a smartcard, which is capable of near field communications (NFC). The user also has access to a mobile device, such as a cellular telephone, that is equipped with a NFC chip. The mobile device is also preferably equipped with web browser software and is connected to the internet. In use, the user brings the smartcard into proximal contact with the cellular telephone. The NFC chip in the cellular telephone energises the smartcard which generates a one time password (OTP) using the secure data stored on it and an authentication technique. In a preferred embodiment, a uniform resource locater (URL) is then created containing the OTP and other secure data stored on the smartcard, which is fed into the browser. The browser then opens up the web site associated with the URL and grants the user access to secure portions of the website according to an access policy. In a particularly preferred embodiment, the website will ask the user for additional logon credentials before access to a particular service is provided.

Note that as used herein, a “website” is given as an example of an “electronic service”, or simply “service”, and the terms are used interchangeably, unless the context clearly requires otherwise.

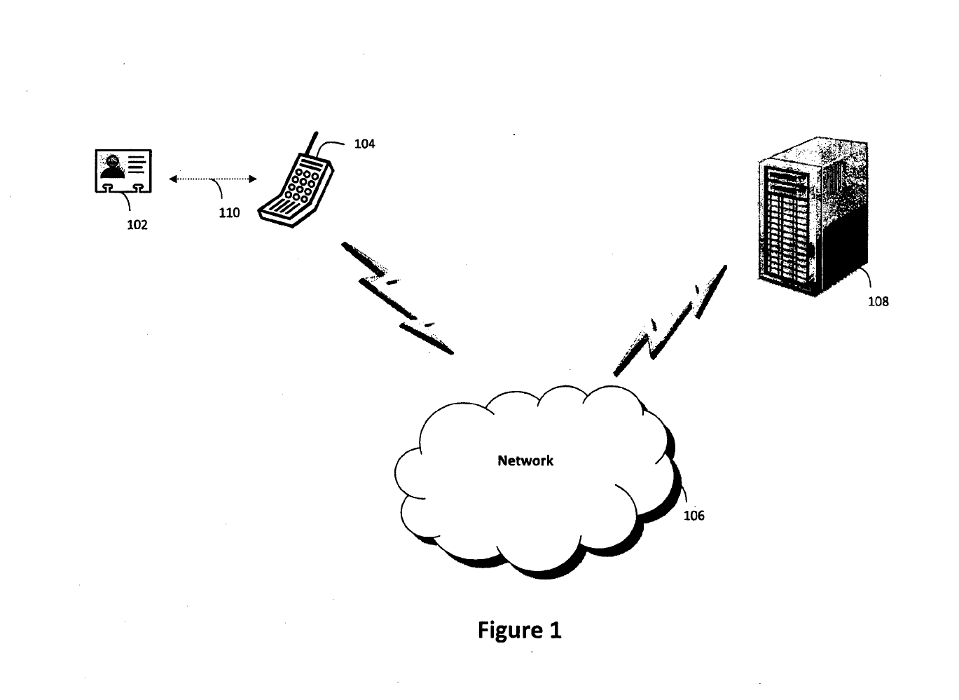

Referring now to FIG. 1, a token 102 for dynamically authenticating a user is brought into proximal contact with a host controller 104, which is configurable to communicate, via the network 106, with a remote server 108 locatable at the server address such that the user is dynamically authenticated on the remote server using the authentication credentials. It will be appreciated by those skilled in the art that the network can be any network suitable for such communications, including but not limited to cellular networks, wi-fi networks or the like.

In one embodiment, the host controller is a mobile device 104 that is configurable for communication with the remote server, in the form of a webserver 108. The mobile device that this invention is envisaged to predominantly work with is a cellular telephone. Some modern cellular telephones, or more particularly smartphones, are already capable of browsing the internet and therefore communicate with publically accessible computer servers such as webservers.

Some next generation smartphones are equipped with a proximity coupling device, in the form of a near field communications (NFC) chip. One example of such a device is the recently released Google® Nexus® S smartphone. It is envisaged that many more devices equipped with NFC capability will be released in the near future, given the increasing prevalence of NFC mobile payment technology.

The NFC chip creates an energy field for communication with the client device, such as, in one embodiment, a smartcard. Near field communication operates in the globally available and unlicensed radio frequency ISM band of 13.56 MHz. Most of the RF energy is concentrated in the allowed 14 kHz bandwidth range, but the full spectral envelope may be as wide as 1.8 MHz when using ASK modulation.

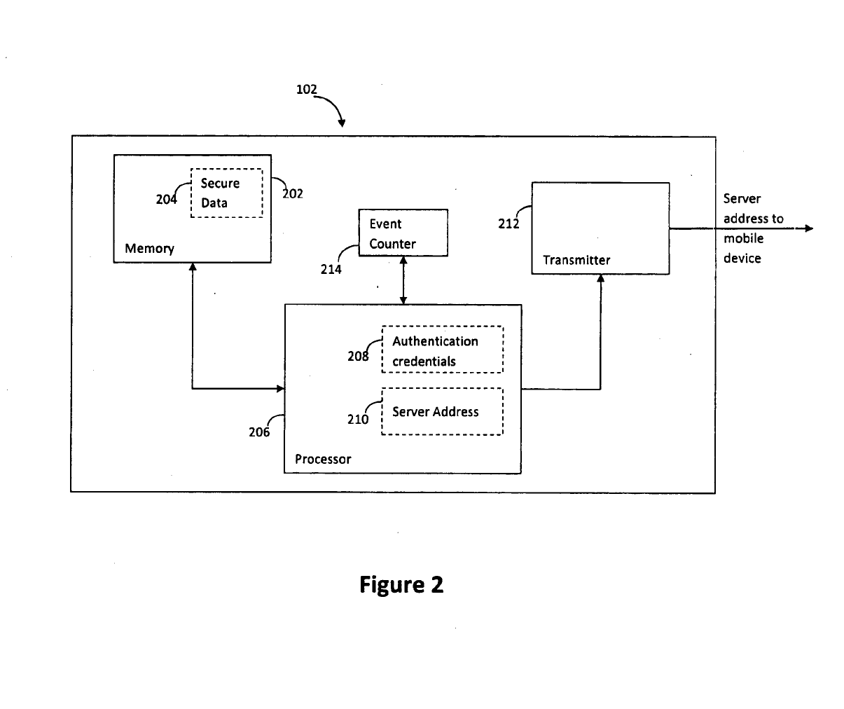

Referring now to FIG. 2, the token 102 includes a memory 202 for storing secure data 204 and a processor 206 for calculating authentication credentials 208 of the user based on the secure data, and for constructing a server address 210 based on the authentication credentials. Also included is a transmitter 212 for transmitting the server address to the smartphone, and an event counter 214 which is incremented each time an OTP is generated and transmitted to a smartphone. In the preferred embodiment, the token 102 is in the form of a smartcard. A smartcard is typically a pocket-sized card with embedded integrated circuits containing logic for memory and/or microprocessor components. The type of smartcard required for near field communications also contains a dose proximity antenna which is used to power the integrated circuit on the card when the card is brought into proximity with a reader, using principles of resonant inductive coupling.

In an alternative embodiment, the token is energised by a local energy source. This embodiment is useful when communication is conducted in an active mode, under which both the host controller and the mobile device generate their own fields. In this mode, an energy field is only activated when a device wishes to transmit data; the field is deactivated if the device is receiving data.

Although the present invention is discussed with reference to smartphones equipped with NFC technology, such smartphones do not form part of the invention and a detailed discussion of smartphones is therefore beyond the scope of this disclosure. The term “smartphone” is used throughout this specification for the sake of convenience and clarity, but it should be clear to those skilled in the art that any computing device capable of near field communications and internet browsing is suitable for use with the present invention.

The secure data 204 includes a username for identifying a user and for determining whether the user has permission to access the remote server 108. In one embodiment, a user policy associated with the username is stored on a policy server. The user policy defines the access rights of the user, based on the username. Examples of user policies include full access, which allows the user complete access to all the services in the remote server, or partial access, which only grants access to a subset of the services available. The user policy also definet whether additional logon information is required. In one embodiment, a username is governed by a mixed access policy in which the smartcard authentication only grants partial access to the system, while full access is only granted when the user provides additional authentication information such as a password or PIN.

The secure data 204 also includes a client key that corresponds to a host key stored on the smartcard 102. The authentication credentials 208 includes an encrypted one-time password (OTP) that is generated based on the secure data. This type of dual key system used for authentication generally involves either symmetric or asymmetric authentication. In symmetric authentication, both the host key and the client keys are identical, and an OTP is only generated for a particular user if the keys match. In this system, both keys must be kept secret otherwise, both keys will become compromised. Additionally, the host key must be different for each user. Therefore, if the system has a large number of users, it is necessary for the host controller to store and manage a large number of keys.

For these reasons, asymmetric authentication is used in the preferred embodiment of the present invention. In asymmetric authentication, the client secret key and the host secret key are mathematically related. Therefore, while the client secret key still needs to be kept secret, the host key can be made public. This authentication method is also known as public key infrastructure (PKI).

In both asymmetric and symmetric authentication, once the client and host keys are matched up, an OTP is generated. In some embodiments, such as for defence related applications, even asymmetrically generated OTPs are not secure enough. In this case, the security of the OTP is enhanced through the use of a PKI hash of constant data

In a simplistic embodiment, the OTP is sent to the smartphone, via transmitter 212. The smartphone is configured to receive the OTP to use it as appropriate. Such an embodiment requires the smartphone to have the capability to receive, interpret and act on the OTP.

However, in the preferred embodiment, the OTP is associated with the username, and linked with a URL which is fed to the browser on the smartphone. The username and OTP is embedded within the URL and the whole URL is passed to transmitter 212. When the smartphone is energised by the NFC field generated by chip inside the smartphone, the URL is received and passed to the browser, which opens up the secure website for the user. In such an embodiment, the user is taken directly to the secure website and the need for a separate step to log the user onto the website is negated. In this or alternate embodiments, additional security is provided by an event counter 214 on the smartcard. Each time an OTP is generated and transmitted from the smartphone, the event counter is incremented. A corresponding event counter is provided on the remote server, which is incremented each time a secure website is accessed by a particular user. Access is only provided if the value of the event counter 214 matches with the corresponding event counter of the remote server.

In the above and other embodiments, since the generation of an OTP takes place on the cryptographic processor on the smartcard itself and is embedded into the URL before it is sent to the smartphone, no additional software is required to be installed on the smartphone. This makes the present invention easily adaptable to work with any device equipped with NFC capability, such as a personal computer. The host device is therefore simply relegated to the role of being a dumb device which takes a URL and opens the associated website in a browser.

Note that PKI is discussed above for exemplary and simplicity purposes only. It will be apparent to those skilled in the art that in other embodiments, the present invention is configured to operate with other authentication protocols, such as OATH, PLAID or the like, or a combination of such protocols. For example, in one embodiment, OATH is used to create an OTP which is them embedded into a PKI certificate. The PKI certificate is then transferred to the smartphone via the transmitter 212 and the smartphone's NFC interface.

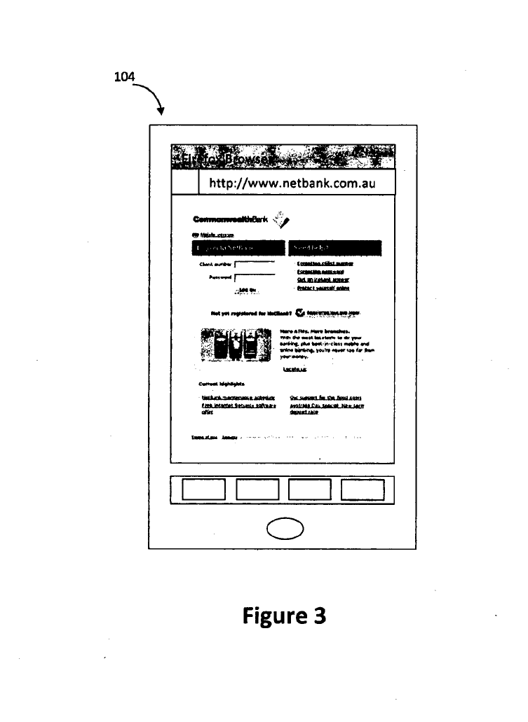

Once the browser receives the URL, it locates the associated remote server and provides access to the server via a standard browser interface, as shown in FIG. 3. One example of a common remote server is a webserver on which is stored a website. The authentication credentials grants the user access to either the whole website or a section of the website, depending on the policy associated with the username. Optionally, access to other sections of the server is granted upon further authentication, such as a user PIN pr password.

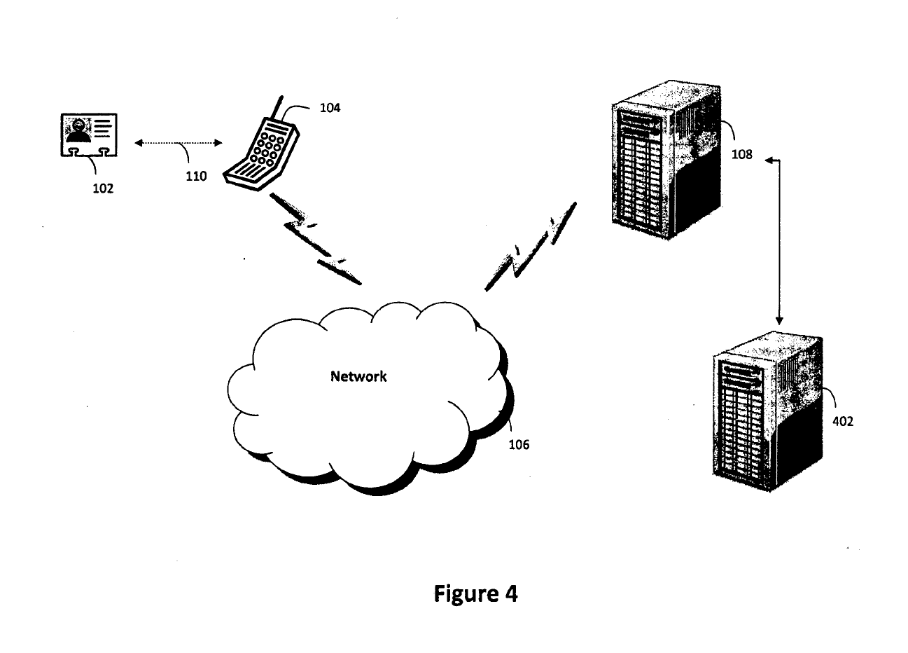

In a straightforward example, the user access policy is simply full access or no access. That is, once the user's access credentials are authenticated, the user is provided full access to the website. Otherwise, the user is precluded from using the website. In more complicated examples, users are provided with different levels of access. For these examples, access to portions of a website is restricted according to any appropriate criteria, such as the rank of an employee. The levels of access are defined in a user access policy which, in the embodiment of FIG. 4, resides in a standalone policy server 402. In other embodiments, the policy server may be part of the smartphone or the remote server or embedded in other devices as appropriate. In the FIG. 4 embodiment, after the OTP is generated, the system determines the level of access a username is entitled to and only presents this portion of the website to the user.

In use, in a particular embodiment, a user brings the smartcard into contact with a smartphone or other suitable reader, as shown in FIG. 1 and FIG. 4. The smartcard is then energised, via induction loop 110, and uses the stored secure data, including the client key and the username, to calculate the user's authentication credentials in the form of a one time password. The authentication credentials are then used to construct a server address, in the form of a URL. In the preferred embodiment, the username and the OTP is embedded within the URL. The URL is then transmitted to the smartcard, wherein the smartcard locates the remote server defined by the URL. Since the URL contains the authentication credentials of the user, that user is dynamically authenticated on the remote server and is able to access electronic services according to the access policy.

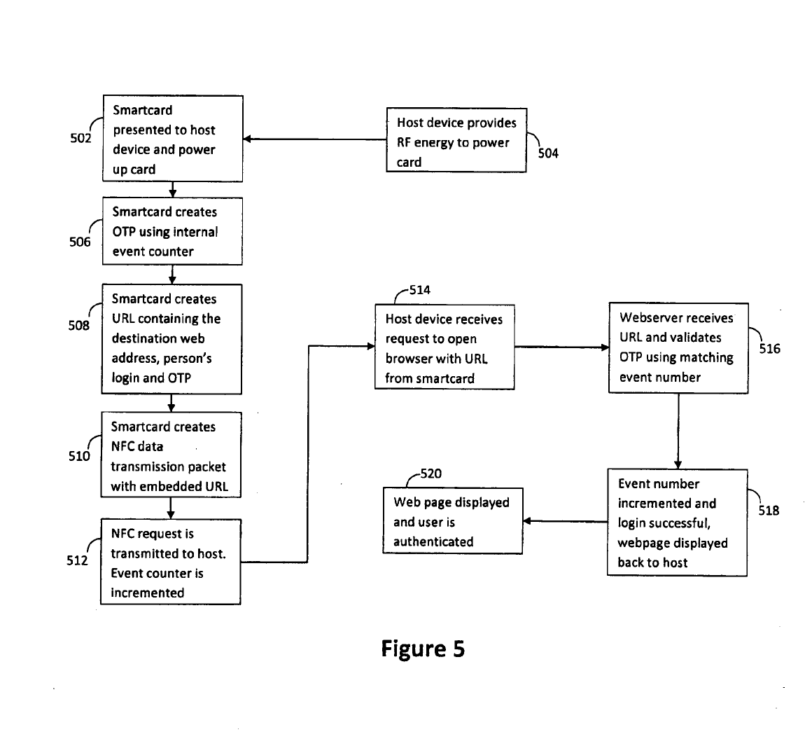

A particularly preferred embodiment of the present invention is shown in the flow diagram of FIG. 5, in which:
At step 502, the user touches their smartcard on the mobile device.
At step 504, the smartcard is energised using a radio field tuned to approximately 13.56 MHz.
At step 506, the smartcard computes a one time password using the internal cryptographic processor of the smartcard and the user's unique client keys stored within the smartcard.
At step 508, the smartcard creates a web URL address which embeds the authentication criteria and sends the full URL (including the OTP) to the mobile device.
At step 510, the smartcard creates a NFC data packet containing the embedded URL for transmission to the mobile device.
At step 512, the NFC data packet is transmitted to the mobile device, and an event counter @@ on the smartcard is incremented.
At step 514 the mobile device receives the request to open a web browser with the URL for the card. Optionally, the mobile device prompts the user for permission to open the browser.
At step 516, the webserver receives the URL and validates the authentication information using a matching event number.
At step 518 the event number on the mobile device is incremented to match the event counter on the smartcard.
At step 520, the mobile device opens the website on the web browser to the user as the login was successful.

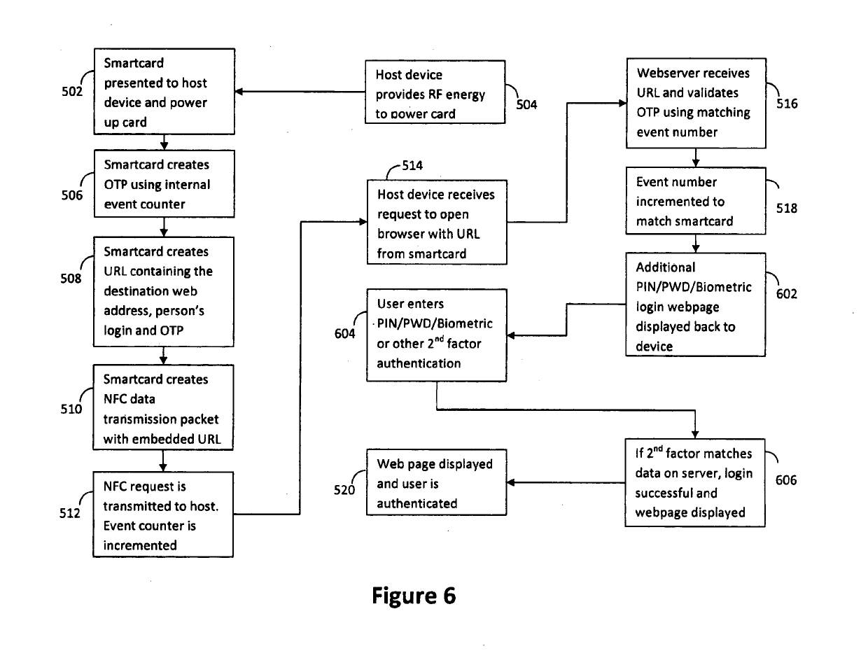

In other embodiments, further authentication is required. Referring to FIG. 6:
After step 518, at step 602, the webserver accesses an additional login page, which is sent to the web browser on the mobile device. The additional login page, in some embodiments, accepts second factor security data such PIN or password or biometric information.
At step 604, the user enters the appropriate second factor security date, which is sent back to the webserver.
At step 606, the webserver verifies the second factor security data, by matching it with security data held on the server. If the verification is successful, the secure website is sent to the mobile device. The website is then opened on the mobile device as per step 520.

A system is described herein for dynamically authenticating a user. The system includes a token and a host controller. In one embodiment, the token includes a memory for storing secure data; a processor for calculating authentication credentials of the user based on the secure data, and for constructing a server address based on the authentication credentials; and a transmitter for transmitting the server address to a host controller wherein the host controller is configurable to communicate with a remote server locatable at the server address.

In this preferred embodiment, the host controller includes a proximity coupling device for coupling with the token; a receiver for receiving the server address; a network interface for communicating with the remote server, wherein the authentication credentials are provided to the remote server thereby to dynamically authenticate the user.

The inventors of the present system envisage several scenarios for which the present invention would be useful. One scenario is for use with mobile online banking functions. The present invention provides a convenient method for authenticating consumers with contactless credit cards to their online banking environment on their mobile device.

By touching the contactless credit card which has been enabled with the mobile device, the contactless credit card (which incorporates a smartcard) internally constructs a web URL address which, among other things, contains the cryptographic authentication information embedded into it. The credit card then emulates an NFC smart tag and requests the host device (phone or computer) open a web browser with the constructed URL. The host mobile device generally does not require any additional application software to be installed onto it, thus allowing for wide acceptance of the approach across multiple platforms.

Another scenario is for use by consumers for online payments. By touching the contactless credit card onto the device, the card may instruct the host mobile device to open a central identity web site using the credentials and keys embedded within the smartcard. The card can then authenticate to the central trusted environment. All future transactions by merchant payment systems can then reference the trusted environment, for examples through an open protocol such as SAML or O-AUTH to verify the authenticity of the remote contactless card.

Unless specifically stated otherwise, it should be appreciated that throughout the specification terms such as “processing,” “computing,” “calculating,” “determining”, analysing” or the like, in some embodiments refer to the action and/or processes of a computer or computing system, or similar electronic computing device, that manipulate and/or transform data represented as physical, such as electronic, quantities into other data similarly represented as physical quantities. Note that when the action and/or processes include several elements, e.g., several steps, no ordering of such elements is implied, unless specifically stated.

Furthermore, as used herein, the term “mobile device” is used as a convenient term to denote a mobile computing platform for “processing,” “computing,” “calculating,” “determining”, analysing” or the like, as defined in preceding paragraph. It will be appreciated by those skilled in the art that, although the present invention is discussed with reference to a mobile device, this is merely one embodiment, selected for the sake of exemplification. In practice, the invention discussed herein should not be read as being limited to use with a mobile device but, rather, any computing platform.

At least one embodiment of each of the methods described herein is in the form of a computer-readable carrier medium carrying a set of instructions (such as a computer program) that are for execution on one or more processors, (such as one or more processors that are part of an information system). Thus, as will be appreciated by those skilled in the art, embodiments of the present invention may be embodied as a method, an apparatus such as a special purpose apparatus, an apparatus such as a data processing system, or a computer-readable carrier medium (such as a computer program product). The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (such as a computer program product on a computer-readable storage medium) carrying computer-readable program code embodied in the medium.

It is to be understood that the above embodiments have been provided only by way of exemplification of this invention, and that further modifications and improvements thereto, as would be apparent to persons skilled in the relevant art, are deemed to fall within the broad scope and ambit of the current invention described and claimed herein.

In the preceding discussion and in the following claims, unless the context specifically requires otherwise, the terms “including” and its variations such as “include”, “includes”, “included” etc are used, and are to be read, in an open-ended fashion, and should be interpreted to mean “including, but not limited to . . . ”. Similarly, unless the context specifically requires otherwise, the term “comprising” and its variations are to be interpreted as being synonymous with the term “including” and its respective variations.

1. A token for dynamically authenticating a user, said token including:
a memory for storing secure data;
a processor for calculating authentication credentials of said user based on said secure data, and for constructing a server address based on said authentication credentials; and
a transmitter for transmitting said server address to a host controller wherein said host controller is configurable to communicate with a remote server locatable at said server address such that said user is dynamically authenticated on said remote server using said authentication credentials.

2. A token according to claim 1 wherein said host controller is a mobile communications device configurable for communication with said remote server.

3. A token according to claim 1 or claim 2 wherein said secure data includes a client key that corresponds to a host key stored on said host controller.

4. A token according to any one of the preceding claims wherein said authentication credentials includes an encrypted one-time password that is generated based on said secure data.

5. A token according to any one of the preceding claims wherein said secure data includes a username for identifying a user and for determining whether said user has permission to access said remote server.

6. A token according to any one of the preceding claims wherein said remote server is a webserver and said authentication credentials grants access to a website stored on said webserver.

7. A token according to any one of the preceding claims wherein said authentication credentials only grants access to one section of said remote server.

8. A token according to claim 7 wherein access to other sections of said remote server is granted upon further authentication by said remote server.

9. A token according to any one of the preceding claims wherein said host controller includes a proximity coupling device and said token is energised when brought into proximity with said proximity coupling device.

10. A token according to any one of the preceding claims wherein said token is energised by a local energy source.

11. A system for dynamically authenticating a user, said system including a token according to any one of the preceding claims and a host controller, said host controller including:
a receiver for receiving said server address;
a network interface for locating and communicating with said remote server, wherein said authentication credentials are provided to said remote server thereby to authenticate said user.

12. A method for dynamically authenticating a user, said method including the steps of:
a) calculating authentication credentials of said user based on secure data stored on a token,
b) constructing a server address based on said authentication credentials; and
c) transmitting said server address to a host controller wherein said host controller is configurable to communicate with a remote server locatable at said server address, such that said user is dynamically authenticated on said remote server using said authentication credentials.

13. A system for dynamically authenticating a user, said system including a token and a host controller, said token including:
a memory for storing secure data;
a processor for calculating authentication credentials of said user based on said secure data, and for constructing a server address based on said authentication credentials; and
a transmitter for transmitting said server address to a host controller wherein said host controller is configurable to communicate with a remote server locatable at said server address; and
said host controller including:
a proximity coupling device for coupling with said token;
a receiver for receiving said server address;
a network interface for communicating with said remote server, wherein said authentication credentials are provided to said remote server thereby to dynamically authenticate said user.
